(19) United States
(12) Patent Application Publication
(10) Pub. No.: US 2004/0261241 A1
(43) Pub. Date: Dec. 30, 2004

(54) Extended tool holder with draw collet

(76) Inventor: Samuel Wesley Crouch, Boulder, CO (US)

Correspondence Address: Emery L. Tracy, P.O. Box 1518, Boulder, CO, 80306-1518, US

(21) Appl. No.: 10/872,611

(22) Filed: Jun. 21, 2004

Related U.S. Application Data
(60) Provisional application No. 60/482,341, filed on Jun. 25, 2003.

(51) Int. Cl. B23C 5/00

(52) U.S. Cl. 29/428; 409/233; 409/234

(57) ABSTRACT

An extended tool holder for holding a cutting tool and receivable within a standard tool holder is provided. The extended tool holder comprises a body having a shank portion and a collet-receiving portion with an aperture extending through the body. A collet is receivable within the collet-receiving portion of the hollow body with the collet having a plurality of fingers closable about at least a portion of the cutting tool. A draw bolt is receivable within the shank portion of the hollow body and connected to the collet for urging the collet into collet receiving portion of the body wherein upon the collet entering the collet receiving portion, the fingers close about the cutting tool.

The present application is a continuation and claims priority of pending U.S. provisional patent application Ser. No. 60/482,341, filed on Jun. 25, 2003, entitled “Extended Tool Holder with Draw Collet”.

### BACKGROUND OF THE INVENTION

1. Field of the Invention

This invention relates generally to a tool holder and, more particularly, the invention relates to an extended tool holder with draw collet which employs a through-the-body draw bolt for reducing bulkiness of the collet nut and inhibiting loosening due to vibration forces that are applied to the unsupported end of the tool holder.

2. Description of the Prior Art

Machine tools such as milling machines and lathes typically hold cutters in universal adapters called tool holders. The tool holders are universal in that they are designed for various machine tools, operations, cutter sizes, and styles. Typically, these tool holders work well for most applications but, there are some applications where the standard tool holder will not suffice and a specialized tool holder must be employed.

Specialized tool holders are commonly employed where it is impractical to use a standard tool holder such as operations to cut deep pockets or holes where reach is an issue and/or the size of the cutter is too small.

Conventional tool holders have limitations in some applications and in their design. For instance, a commonly used extended tool holder has significant drawbacks in the way the tool holder restrains the cutter. The conventional tool holder employs an external nut to compress the collet which, in turn, tightens around the cutting tool shank. This design has two weaknesses in that the compressing nut increases the size of the tool holder end and the nut can be loosened by vibration. Another type of extended tool holder that does not use a collet, holds the cutter by shrink fit. Although this design overcomes the above listed faults, it is still impractical and inconvenient in use to the machinist in that user must heat the holder and/or cool the cutter in order to get them to shrink fit rigidly together.

Accordingly, there exists a need for an extended tool holder with a draw collet which overcomes the drawbacks of conventional tool holders by employing a through-the-body draw bolt that reduces the bulkiness of the collet nut and also inhibits loosening due to vibration forces that are applied to the unsupported end of the tool holder. Additionally, a need exists for an extended tool holder with a draw collet that does not require apparatuses and facilities for heating and cooling of the tools in order to achieve a shrink fit.

### SUMMARY

The present invention is an extended tool holder for holding a cutting tool and receivable within a standard tool holder. The extended tool holder comprises a body having a shank portion and a collet-receiving portion with an aperture extending through the body. A collet is receivable within the collet-receiving portion of the hollow body with the collet having a plurality of fingers closable about at least a portion of the cutting tool. A draw bolt is receivable within the shank portion of the hollow body and connected to the collet for urging the collet into collet receiving portion of the body wherein upon the collet entering the collet receiving portion, the fingers close about the cutting tool.

In addition, the present invention includes a method for holding a cutting tool and receivable within a standard tool holder. The method comprises providing a body having a first end and a second end, inserting a collet into the first end of the body, the collet having a plurality of flexible fingers, inserting a draw bolt into the second end of the body, threadably connecting the collet to the draw bolt, tightening the draw bolt into the collet, urging the collet into the first end of the body, and tightening the fingers of the collet about the cutting tool.

The present invention further includes an apparatus for holding an object. The apparatus comprises a holder having a first end and a second end, an aperture extending from the first end to the second end, collet means for holding the object, and draw means connected to the collet means for tightening the collet means about the object.

### BRIEF DESCRIPTION OF THE DRAWINGS

FIG. 1a is a front perspective view illustrating an extended tool holder with draw collet, constructed in accordance with the invention;

FIG. 1b is a rear perspective view illustrating the extended tool holder with draw collet, constructed in accordance with the present invention;

FIG. 2a is a front perspective exploded view illustrating the components of the extended tool holder with draw collet, constructed in accordance with the invention;

FIG. 2b is a rear perspective exploded view illustrating the components of the extended tool holder with draw collet, constructed in accordance with the present invention;

FIG. 3a is a top sectional view illustrating the extended tool holder with draw collet, constructed in accordance with the invention;

FIG. 3b is an end sectional view illustrating the extended tool holder with draw collet, constructed in accordance with the present invention;

FIG. 3c is an elevational side view illustrating the extended tool holder with draw collet, constructed in accordance with the present invention;

FIG. 4a is a front perspective view illustrating the collet component of the extended tool holder with draw collet, constructed in accordance with the invention; and

FIG. 4b is a rear perspective view illustrating the collet component of the extended tool holder with draw collet, constructed in accordance with the invention.

### DETAILED DESCRIPTION OF THE PREFERRED EMBODIMENTS

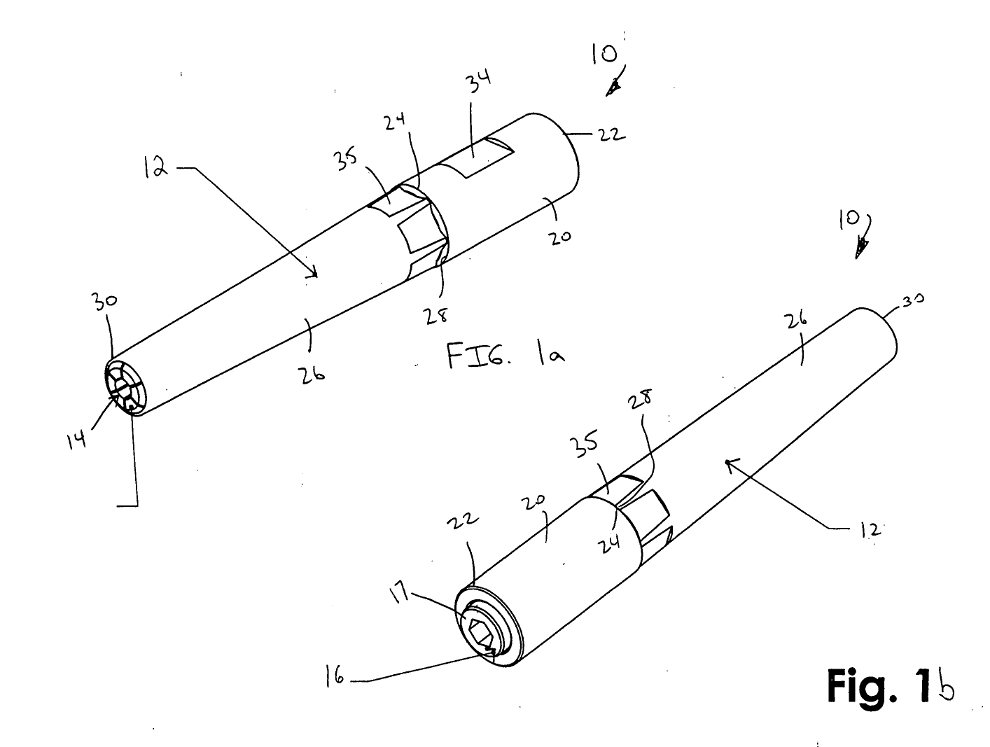

As illustrated in FIGS. 1a and 1b, the present invention is an extended tool holder, indicated generally at 10, which fits into a standard tool holder (not shown) allowing a cutting tool (not shown) to be held in a manner that is practical for the application. While the extended tool holder 10 of the present invention has been and will be described as holding a cutting tool such as a drill bits, boring bars, reamers, end mills, etc., it is within the scope of the present invention for the extended tool holder 10 to hold any type of tool within any type of standard tool holder.

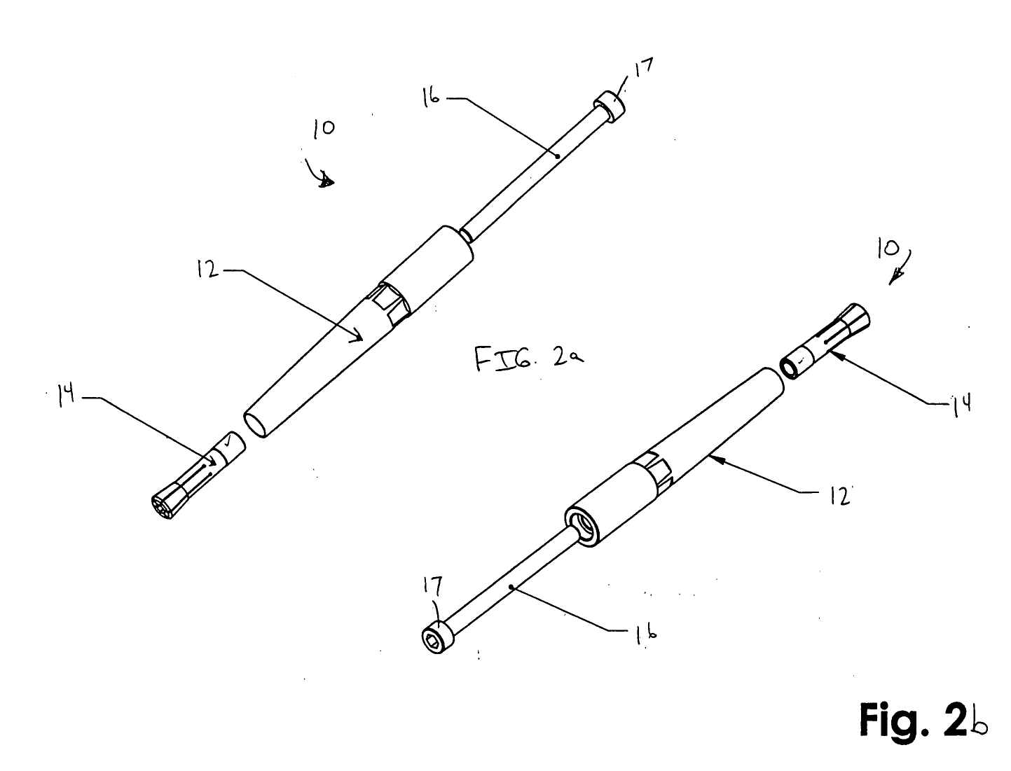

The extended tool holder 10 has a body 12 for enclosing a collet 14 and a draw bolt 16. Preferably, the collet 14 is tapered corresponding to the taper of an aperture 18 within the body 12. As illustrated in FIGS. 2a and 2b, the body 12 of the extended tool holder 10 accepts the collet 14 and the draw bolt 16 in a concentric fashion.

The body 12 of the extended tool holder 10 of the present invention includes a shank portion 20 having a first end 22 and a second end 24 and a collet-receiving portion 26 having a first end 28 and a second end 30. Preferably, the collet-receiving portion 26 of the body 12 is tapered from the first end 28 to the second end 30. The aperture 18 extends through the body 12 from the first end 22 of the shank portion 20 to the second end 30 of the collet-receiving portion 26. Preferably, the aperture 18 is tapered within the collet-receiving portion 26 for receiving the tapered collet 14.

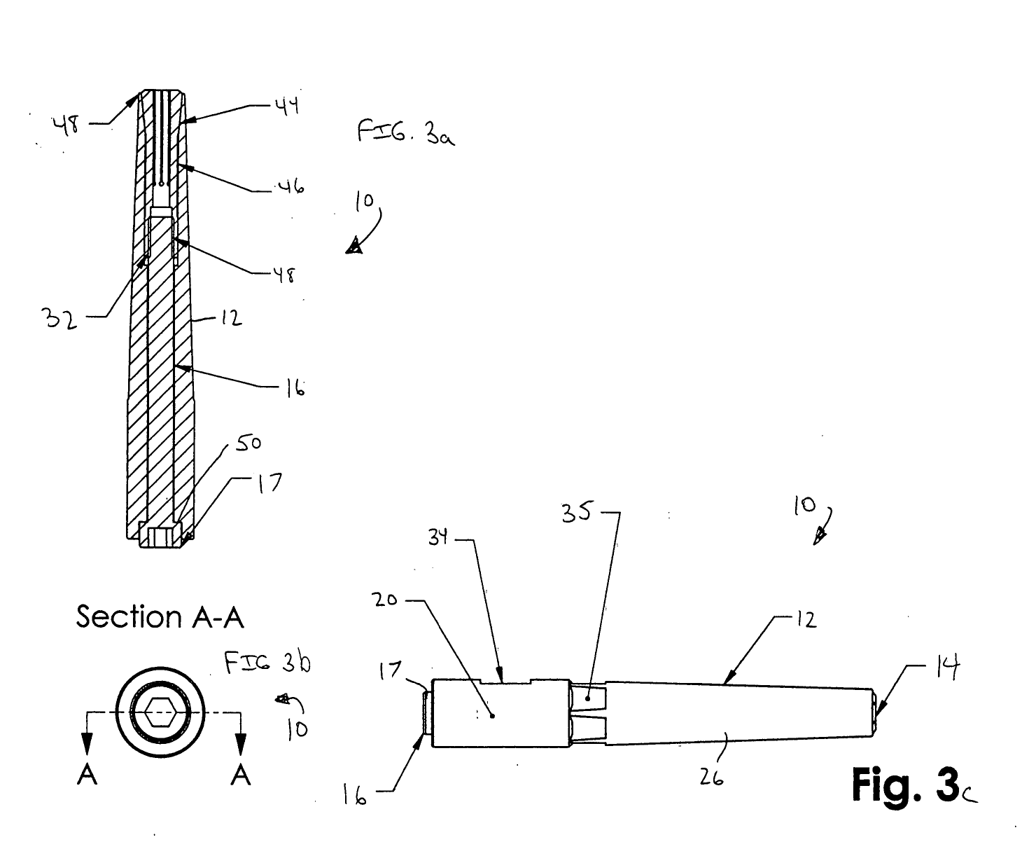

As illustrated in FIGS. 3a-3c, the tapered collet 14 is receivable within the aperture 18 of the tapered collet-receiving portion 26 of the body 12. The draw bolt 16 fits through the aperture 18 within the shank portion 20 of the body 12 and threads into a threaded aperture 32 of the collet 14. The shank portion 20 of the body 12 of the extended tool holder 10 preferably has at least one flat area 34 formed therein for locking and orienting the body 12 of the extended tool holder 10 in the chuck (not shown) or the machine tool holder. Additional flat areas 35 are preferably positioned radially on the tapered collet-receiving portion 26 of the extended tool holder 10.

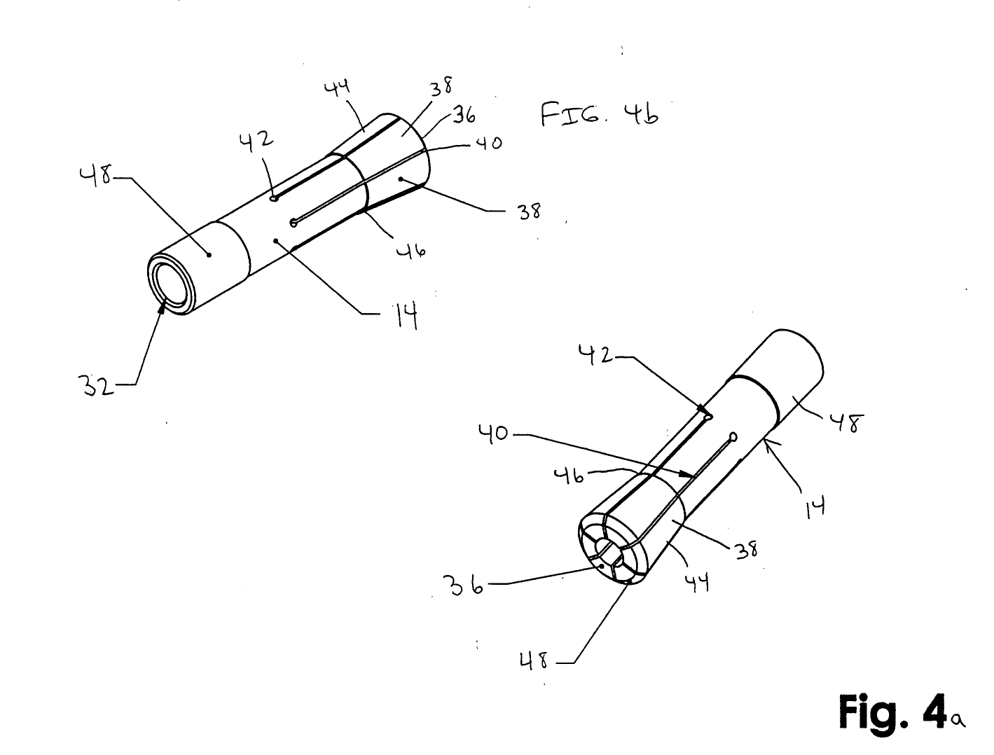

As illustrated in FIGS. 4a and 4b, the end 36 of the collet 14 includes a plurality of flexible fingers 38 which are manifested by axial slots 40 terminating at a strain relief spot 42. A tapered portion 44 is provided on the outside diameter of the collet 14 and terminates at a relieved portion 46. A raised portion 48 is the shank of the collet 14. The threaded aperture 32 is provided to a predetermined depth in the collet 14 for receiving at least portion of the draw bolt 16.

In operation of the extended tool holder 10 of the present invention, a user uses the draw collet extended tool holder 10 in conjunction with a machine tool holder (not shown). The shank portion of a cutting tool (not shown) is firmly held by the extended tool holder 10. This is accomplished by placing the cutter shank (not shown) in the collet 12 between the fingers 38, as illustrated in FIGS. 4a and 4b, which is sized to precisely fit the shank of the cutting tool. Then the collet 14, as illustrated in FIGS. 2a and 2b, while positioned within the second end 30 of the collet receiving portion 26 of the tool holder body 10, is tightened by the draw bolt 16 placed through the first end 22 of the shank portion 20 of the tool holder 10 and threaded, as illustrated in FIGS. 3a-3c, into the threaded aperture 32 of the collet 14.

Once the assembly is in place, the user employs wrenches placed on the flat areas 35 formed in the collet-receiving portion 26 of the body 12 and the head 17 of the draw bolt 16 to manipulate the draw bolt 16 into the collet 14 and the collet 14 into the body 12. This action causes the fingers 38 of the collet 14 to close around the cutter shank (not shown) by the action of the collet fingers 38 which are preferably tapered on the diameter and free to react to the taper bore of the body 12 by the axial slots 40 which allow radial movement of the fingers 38. Furthermore, the end of the collet 14 includes a raised portion 48 which fits precisely into the aperture 18 of the body 12 and further guides the collet 14 straight, maintaining concentricity between the collet 14 and the body 12.

Upon completion of tightening the cutter, the extended tool holder 10 is now placed into the machine tool holder (not shown). The flat areas 34 formed on the shank portion 20 of the extended tool holder 10 allow the user to further secure and orient the extended tool holder 10 in the machine tool holder.

In sum, the present invention is an extended tool holder 10 comprising a body 12 having a shank for fit in a collet or larger tool holder, flats 34 for gripping with a wrench while tightening, at least one flat 35 formed on the body 12 for locking in place and orienting in another tool holder, a tapered body 12 on the outside diameter for reducing the diameter at the end, and a tapered internal diameter aperture 18 used for closing a collet 14 when pulled into the tapered aperture 18. It has an aperture 18 through the center that incorporates various diameters that provide a shoulder 50 to inhibit the extent of the draw bolt head 16, a guide for the fit of the guide portion of the collet 14. The counter bore in the first end 22 of the shank portion 20 is constructed so that the head 17 of the draw bolt 16 extends outside the body 12 for ease of removal of the cutting tool by allowing the operator to tap the draw bolt 16 forward thereby pushing the collet 14 forward.

The extended tool holder 10 further comprises a collet 14 which fits into the body 12 and is tapered with fingers 38 to close around the shank of the cutting tool when the collet 14 is pulled into the body 12. The collet 14 also features a guide diameter on the end opposite the tapered end and aligns the collet 14 in the holder body 12 in a precision manner. The guide end of the collet 14 has an internally threaded aperture 32 that are employed to engage the draw bolt 16. Furthermore, the collet 14 has a relief portion 46 that ensures contact between the guide section and the taper section with those details in the tool holder body 10.

In addition, the extended tool holder 10 comprises a draw bolt 16 that is used to pull in the collet 14 through the body 12 of the tool holder 10 whereby a) a cutting tool is placed into the collet 14 and is tightened by using wrenches on the body flats 34 and the draw bolt 16 which, b) pulls the collet 14 deeper into the holder body 12 and reacts against the internal tapered aperture 18 causing the fingers 38 of the collet 14 to close. Having secured the cutting tool into the extended tool holder 10, the assembly is placed into another tool holder. The effect of having this mechanism is to allow a precision and ridged manner to hold small tools and, by the extended fashion of the tool holder 10, allows the user to have access to places that are normally difficult to reach.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. An extended tool holder for holding a cutting tool and receivable within a standard tool holder, the extended tool holder comprising:
a body having a shank portion and a collet-receiving portion, an aperture extending through the body;
a collet receivable within the collet receiving portion of the hollow body, the collet having a plurality of fingers closable about at least a portion of the cutting tool; and
a draw bolt receivable within the shank portion of the hollow body and connected to the collet for urging the collet into collet receiving portion of the body;
wherein upon the collet entering the collet-receiving portion, the fingers close about the cutting tool.

2. The extended tool holder of claim 1 and further comprising:
at least one flat area formed on the collet-receiving portion of the body.

3. The extended tool holder of claim 1 and further comprising:
at least one flat area formed on the shank portion of the body.

4. The extended tool holder of claim 1 wherein the aperture of the body within the collet-receiving portion is tapered.

5. The extended tool holder of claim 4 wherein the collet is tapered corresponding to the taper of the aperture of the collet receiving portion.

6. The extended tool holder of claim 1 and further comprising:
a shoulder formed about the aperture on the shank portion of the body for limiting the extent of the draw bolt into the aperture.

7. The extended tool holder of claim 1 wherein at least a portion of the draw bolt is threaded and further comprising:
a threaded aperture in the collet for receiving at least a portion of the threaded draw bolt.

8. The extended tool holder of claim 1 and further comprising:
a relief portion on the collet for seating within the aperture.

9. The extended tool holder of claim 1 wherein the collet has a shank, the shank being concentrically receivable within the aperture.

10. The extended tool holder of claim 1 wherein the draw bolt has a head, the head extending beyond the end of the shank portion of the body.

11. A method for holding a cutting tool and receivable within a standard tool holder, the method comprising:
providing a body having a first end and a second end;
inserting a collet into the first end of the body, the collet having a plurality of flexible fingers;
inserting a draw bolt into the second end of the body;
threadably connecting the collet to the draw bolt;
tightening the draw bolt into the collet;
urging the collet into the first end of the body; and
tightening the fingers of the collet about the cutting tool.

12. The method of claim 11 and further comprising:
forming at least one flat area on the body.

13. The method of claim 11 extended tool holder of claim 1 and further comprising:
at least one flat area formed on the shank portion of the body.

14. The method of claim 11 and further comprising:
tapering the aperture of the body; and
tapering the collet corresponding to the taper of the aperture.

15. The method of claim 11 and further comprising:
limiting the extent of the draw bolt into the aperture.

16. An apparatus for holding an object, the apparatus comprising:
a holder having a first end and a second end;
an aperture extending from the first end to the second end;
collet means for holding the object; and
draw means connected to the collet means for tightening the collet means about the object.

17. The apparatus of claim 16 wherein the collet means has a plurality of fingers closable about at least a portion of the object.

18. The apparatus of claim 16 and further comprising:
at least one flat area formed on the collet-receiving portion of the body.

19. The apparatus of claim 16 and further comprising:
retention and orientation means formed on the body for retaining and orienting the body into a standard tool holder.

20. The apparatus of claim 16 wherein at least a portion of the aperture of the body is tapered.

21. The apparatus of claim 20 wherein the collet is tapered corresponding to the taper of the aperture of the body.

22. The apparatus of claim 16 wherein the draw means is a draw bolt and at least a portion of the draw bolt is threaded and further comprising:
a threaded aperture in the collet for receiving at least a portion of the threaded draw bolt.
